(19) United States
(12) Patent Application Publication
(10) Pub. No.: US 2004/0212936 A1
(43) Pub. Date: Oct. 28, 2004

(54) Diode-string substrate-pumped electrostatic discharge protection

(76) Inventors: Craig T. Salling, Plano, TX (US); Charvaka Duvvury, Plano, TX (US)

Correspondence Address: TEXAS INSTRUMENTS INCORPORATED, P O BOX 655474, M/S 3999, DALLAS, TX, 75265

(21) Appl. No.: 10/256,748

(22) Filed: Sep. 27, 2002

(51) Int. Cl. H02H 9/00

(52) U.S. Cl. 361/56; 361/111

(57) ABSTRACT

A CMOS electrostatic discharge (ESD) protection circuit in a substrate of a first conductivity type, in which a discharge circuit having an MOS transistor in the substrate is operable to discharge the ESD pulse to ground. A drive circuit has a plurality of forward-biased diodes in separate wells of the opposite conductivity type, connected as a string in forward direction. During an ESD event, the diode string uses a portion of the ESD pulse's voltage to enter a high-conductance, conductivity-modulated state, and to provide a large substrate current, and consequently a substrate voltage drop, to turn-on the MOS transistor so that it will ground the ESD pulse.

### FIELD OF THE INVENTION

The present invention is related in general to the field of electronic systems and semiconductor devices and more specifically to the field of electrostatic discharge (ESD) protection by substrate pump concepts involving strings of diodes.

### DESCRIPTION OF THE RELATED ART

Integrated circuits (ICs) may be severely damaged by electrostatic discharge (ESD) events. A major source of ESD exposure to ICs is from the charged human body (described by the “Human Body Model”, HBM); the discharge of the human body generates peak currents of several amperes to the IC for about 100 ns. A second source of ESD is from metallic objects (described by the “machine model”, MM); it can generate transients with significantly higher rise times and current levels than the HBM ESD source. A third source is described by the “charged device model” (CDM), in which the IC itself becomes charged and discharges to ground in rise times less than 500 ps in the opposite direction than the HBM and MM ESD sources. More detail on ESD phenomena and approaches for protection in ICs can be found in A. Amerasekera and C. Duvvury, “ESD in Silicon Integrated Circuits” (2^{nd} edition, John Wiley & Sons LTD. London, 2002), and C. Duvvury, “ESD: Design for IC Chip Quality and Reliability” (Int. Symp. Quality in El. Designs, 2000, pp. 251-259; ref. of recent literature).

ESD phenomena in ICs are growing in importance as the demand for higher operating speed, smaller operating voltages, higher packing density and reduced cost drives a reduction of all device dimensions. This generally implies thinner dielectric layers, higher doping levels with more abrupt doping transitions, and higher electric fields—all factors that contribute to an increased sensitivity to damaging ESD events.

The most common protection schemes used in metal-oxide-semiconductor (MOS) ICs rely on the parasitic bipolar transistor associated with an nMOS device whose drain is connected to the pin to be protected and whose source is tied to ground. The protection level or failure threshold can be set by varying the nMOS device width from the drain to the source under the gate oxide of the nMOS device. Under stress conditions, the dominant current conduction path between the protected pin and ground involves the parasitic bipolar transistor of that nMOS device. This parasitic bipolar transistor operates in the snapback region under pin positive with respect to ground stress events.

The dominant failure mechanism, found in the nMOS protection device operating as a parasitic bipolar transistor in snapback conditions, is the onset of second breakdown. Second breakdown is a phenomenon that induces thermal runaway in the device wherever the reduction of the impact ionization current is offset by the thermal generation of carriers. Second breakdown is initiated in a device under stress as a result of self-heating. The peak nMOS device temperature, at which second breakdown is initiated, is known to increase with the stress current level.

Many circuits have been proposed and implemented for protecting ICs from ESD. One method is biasing the substrate of ESD protection circuits in an IC. Such substrate biasing can be effective in improving the response of a multi-finger MOS transistor which is used to conduct an ESD discharge to ground. Substrate biasing, however, can cause the threshold voltages for devices to change from their nominal values, thus affecting device operation. In addition, substrate biasing under steady-state condition generates heat and increases power losses.

In the recent U.S. Pat. No. 5,940,258, issued Aug. 17, 1999 (Duvvury, “Semiconductor ESD Protection Circuit”), a substrate pump ESD protection bias technique has been described for standard epitaxial and non-epitaxial devices. This concept has been successfully applied to bulk CMOS technologies, including devices with thin epitaxial silicided features. Unfortunately, the described technique does not always have a fast enough response time for ESD events; in addition, the drive circuit may have a relatively high capacitance and leakage current.

In the publication “Design on the Low-Leakage Diode String for using in the Power-Rail ESD Clamp Circuits in a 0.35 μm Silicide CMOS Process” (by Ming-Dou Ker and Wen-Yu Lo, IEEE Trans. Solid-State Circ., vol. 35, pp. 601-611, 2000), a string of n-well diodes in p-substrate is used for connecting Vdd to ground (Vss) in power rail ESD clamp circuits. The proposition consumes lots of precious silicon area and is not compatible with fail-safe operation.

In the previous publication “Novel Clamp Circuits for IC Power Supply Protection” (by T. Maloney and S. Dabral, Proc. EOS/ESD Symp., 1995, pp. 1-12), circuits are described, which are made of several components synchronized in an impractically complicated sequence. They are not compatible with fail-safe operation.

An urgent need has therefore arisen for a coherent, low-cost method of compact ESD protection devices compatible with high response speed, low capacitance and low leakage current using standard CMOS processing. The device structures should further provide excellent electrical performance, mechanical stability and high reliability. The fabrication method should be simple, yet flexible enough for different semiconductor product families and a wide spectrum of design and process variations. Preferably, these innovations should be accomplished without extending production cycle time, and using the installed equipment, so that no investment in new manufacturing machines is needed.

### SUMMARY OF THE INVENTION

The present invention describes a CMOS electrostatic discharge (ESD) protection circuit in a substrate of a first conductivity type, in which a discharge circuit having an MOS transistor in the substrate is operable to discharge the ESD pulse to ground. A drive circuit has a plurality of forward-biased diodes in separate wells of the opposite conductivity type, connected as a string in forward direction. During an ESD event, the diode string uses a portion of the ESD pulse's voltage to enter a high-conductance, conductivity-modulated state, and to provide a large substrate current, and consequently a substrate voltage drop, to turn-on the MOS transistor so that it will ground the ESD pulse.

It is a technical advantage of the invention that the plurality of diodes in the drive circuit cause fast response time of the circuit, and the drive circuit has low capacitance and low leakage current.

Another technical advantage is that the number of diodes can be adjusted depending on the voltage application limits.

In the first preferred embodiment, the anode of the string of diodes is connected to the pad (I/O or power) and the cathode of the string is connected to the substrate of the MOS transistor as well as to ground via a resistor (which is either the substrate resistance or an additional resistive element including a poly resistor). The first conductivity type is p-type and the discharge circuit MOS transistor is an nMOS transistor.

In the second preferred embodiment, the first conductivity type is n-type and the discharge circuit MOS transistor is a pMOS transistor.

In the third preferred embodiment, the bias tap can be taken from an extra diode. The number of diodes in the string can be adjusted depending on the voltage application limits.

In the fourth preferred embodiment, the pad is an output pad in need of ESD protection. The output pull-down nMOS transistor forms a pre-driver-controlled circuit with substrate bias.

In the fifth preferred embodiment, the substrate bias is applied to cascoded transistors in order to provide voltage-tolerant protection. This embodiment can be used for input or output pads.

In the sixth preferred embodiment, a diode is in series between the pad and the drain of the MOS transistor and a plurality of diodes in the drive circuit.

In the seventh preferred embodiment, multiple diode-triggered nMOS discharge circuits (“clamps”) are placed between Vdd and Vss, preferably at every I/O cell. The ESD current is shunted to the Vdd/Vss buses by diodes connected to the bondpad such that they are reverse-biased during normal operation. During ESD, the diodes conduct and a potential difference builds up between the Vdd/Vss buses, until it is discharged by triggering of the diode-triggered nMOS clamps.

It is a technical advantage of the present method of preventing ESD damage that it may be implemented using standard semiconductor processing techniques. The present ESD protection circuitry, therefore, does not add significant processing time or expense to the IC.

The technical advances represented by the invention, as well as the aspects thereof, will become apparent from the following description of the preferred embodiments of the invention, when considered in conjunction with the accompanying drawings and the novel features set forth in the appended claims.

### BRIEF DESCRIPTION OF THE DRAWINGS

FIGS. 1A, 1B, and 1C depict schematic circuit diagrams of the basic approach to a semiconductor substrate current pump scheme for an ESD protection circuit according to the invention, for input or power pads/pins.

FIG. 1A is a schematic circuit diagram of the first embodiment of the invention, using an nMOS transistor in the discharge circuit.

FIG. 1B is a schematic circuit diagram of the second embodiment of the invention, using a pMOS transistor in the discharge circuit.

FIG. 1C is a schematic circuit diagram of the third embodiment of the invention, using bias tap for voltage application limits.

FIG. 2 shows a simplified cross section of a semiconductor of a first conductivity type with a string of diodes in separate wells of the opposite conductivity type in the first embodiment of the ESD protection circuit according to the invention.

FIG. 3 shows a simplified top view of the MOS transistor in the substrate of first conductivity type and the string of diodes in separate wells of the opposite conductivity type in a variation of the first embodiment of the ESD protection circuit according to the invention.

FIG. 4 depicts a schematic circuit diagram of the fourth embodiment of the invention, wherein the ESD protection circuit, based on the substrate current pump scheme of the invention, is used for output pad protection.

FIG. 5 depicts a schematic circuit diagram of the fifth embodiment of the invention for voltage-tolerant input or output protection, wherein the substrate bias is applied to cascoded transistors.

FIG. 6 depicts a schematic circuit diagram of the sixth embodiment of the invention, wherein a diode is in series between the pad and the drain of the MOS transistor.

FIG. 7 depicts a schematic circuit diagram of the seventh embodiment of the invention, wherein multiple diode-triggered nMOS clamps are placed between Vdd and Vss, preferably at every I/O cell.

### DETAILED DESCRIPTION OF THE PREFERRED EMBODIMENTS

The present invention is related to U.S. Pat. No. 5,940,258, issued on Aug. 17, 1999 (Duvvury, “Semiconductor ESD Protection Circuit”), which is herewith incorporated by reference. The present invention is further related to U.S. patent application Ser. No. 10/146,158, filed on May 15, 2002 (Duvvury et al., “Substrate Pump ESD Protection for Silicon on Insulator Technologies”), which is herewith incorporated by reference.

Failsafe I/O circuits are traditionally defined as circuits on the bond pad that have no path for DC current regardless whether the device is powered “on” or “off”. To create ESD protection under failsafe circuit condition is particularly important for multi-voltage systems that vary I/O operating voltage in order to conserve power.

An additional concern the I/O's should meet for their ESD protection is the amount of output capacitance seen at the bond pad. Since output capacitance restricts the overall bandwidth for bus solutions, I/O interfaces tend to be restrictive on allowable output capacitance. Providing solutions that have less capacitive loading will provide a more successful circuit design.

Another obvious concern is chip real estate area. Although tolerance to higher voltage is gained, drain-extended transistors tend to have lower I-drive compared to their standard transistor counterparts. This implies a disadvantage in the form of chip real estate. Area reduction needs to be leveraged off the intrinsic properties of the drain-extended devices themselves.

For ESD phenomena in drain-extended transistors, the use of an n-well under the drain in nMOS devices allows higher voltage tolerance, but this advantage is off-set by an inefficient lateral npn turn-on with high holding voltage. Consequently, the device ESD performance is poor because of the high power dissipation. Previously proposed improvements include the integration of an SCR (U.S. Pat. No. 5,903,032, issued May 11, 1999, Duvvury, “Power Device Integration for Built-in ESD Robustness”), the application of the gate coupling effect (C. Duvvury et al., “Efficient npn Operation in High Voltage nMOSFET for ESD Robustness”, IEDM Digest, 1995), and an n+/p+ design (U.S. Pat. No. 4,939,616, issued Jul. 3, 1990, Rountree, “Circuit Structure with Enhanced Electrostatic Discharge Protection”). These improvements have become more challenging with the recent technical advances of shallow trench isolation (STI), low resistance substrate, and silicided diffusions.

It is of particular interest for the current CMOS technologies, to optimize ESD protection structures by selecting circuit and geometrical designs, such as spacings, to obtain the desired trigger voltage, allow high-voltage circuit operation, and provide ESD robustness. Generally needed is an ESD protection for I/O and power pads compatible with CMOS processing, which is low-capacitance, low-leakage, compact (little area-consuming), and fast (short reaction time).

In the solution provided by the invention, a string of several forward-biased n-well diodes is connected between the bond pad (I/O or power) and the p-substrate local to an nMOS clamp (as defined herein, “clamp” refers to the discharge circuit of a protection circuit, which has an MOS transistor formed in the substrate, operable to discharge an ESD pulse to ground).

While the starting material for the device embodiments of the invention is preferably silicon, it may also be silicon germanium, gallium arsenide, or any other semiconductor material used in integrated circuit fabrication. In most of the following figures, the conductivity of the semiconductor substrate is p-type. It should be stressed, however, that all considerations remain valid for the opposite conductivity; consequently, the semiconductor substrate could be n-type. The p-doping species are selected from a group consisting of boron, aluminum, gallium, and indium. The n-doping species are selected from arsenic, phosphorus, antimony, and bismuth.

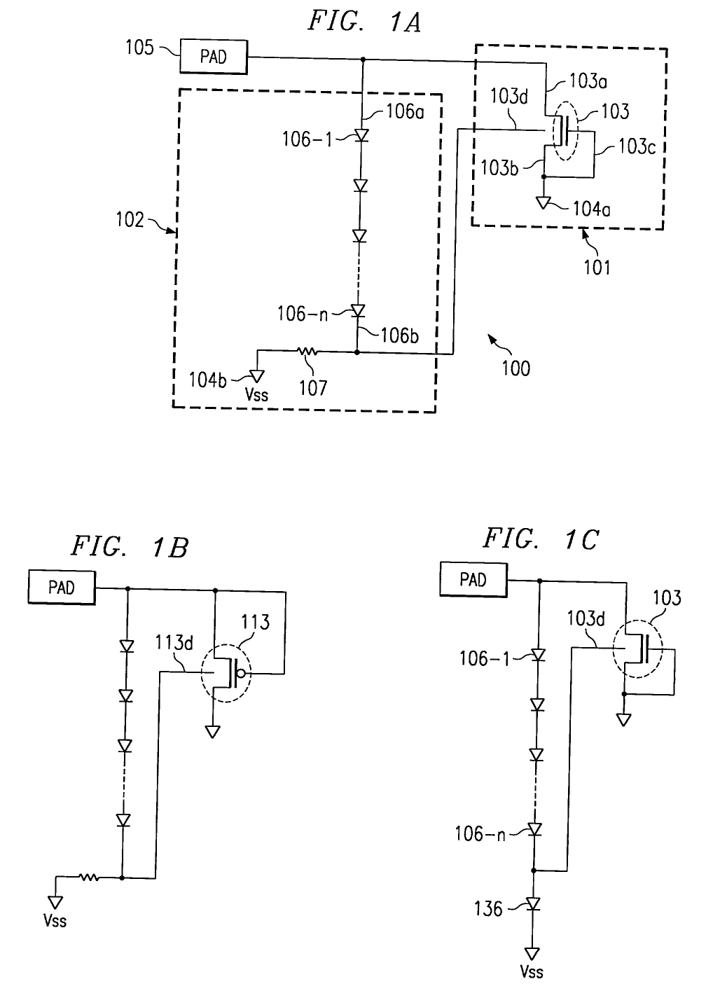

FIG. 1A summarizes the basic approach of the present invention to protect input or power pins (I/O or power pads) of CMOS integrated circuits (IC) against an ESD pulse. FIG. 1A represents the first preferred embodiment of the invention. The ESD protection circuit, generally designated 100, consists of a discharge circuit 101 and a drive circuit 102. The discharge circuit 101 has an nMOS transistor 103 formed in p-type substrate and is operable to discharge the ESD pulse to ground 104a. The drain 103a of transistor 103 is connected to pad 105, and the source 103b and the gate 103c to ground 104a; the substrate 103d is connected to the drive circuit 102.

Drive circuit 102 has a string of diodes 106-1 to 106-n, which are located in separate n-wells; the diodes are connected in forward direction; the anode 106a of the string is connected to pad 105 and to the drain 103a of the MOS transistor 103, and the cathode 106b of the string is connected to the transistor substrate 103d and, through a resistor 107, to Vss (ground) 104b. The number of diodes in the string can be adjusted dependent on the voltage limit of the intended device application by connecting drain 103a of transistor 103 to a select node within the diode string, tapping off a select number of diodes.

The resistor 107 can be the substrate resistance or an additional resistive element including a poly resistor.

During an ESD event, the diode string uses a portion of the ESD pulse's voltage to enter into a high-conductance, conductivity-modulated state; a large current (for instance, 100 mA) is provided into the substrate 103d (for instance, Rsub=10 Ω) where it causes a substrate voltage drop (so-called “substrate pumping”). This voltage drop turns on strongly the lateral npn of transistor 103 so that the bulk of the ESD pulse can be safely grounded. Additional substrate current is provided by conduction of the vertical pnp associated with each diode.

As a result of the diode string connections and its reactions to an ESD pulse, the drive circuit 102 has

rapid response time,

low capacitance, and

low leakage current.

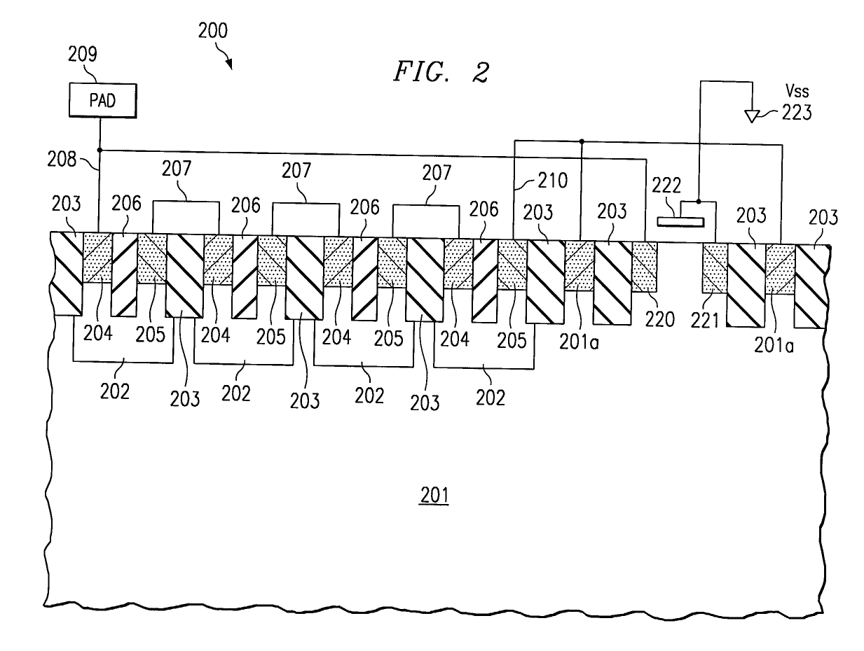

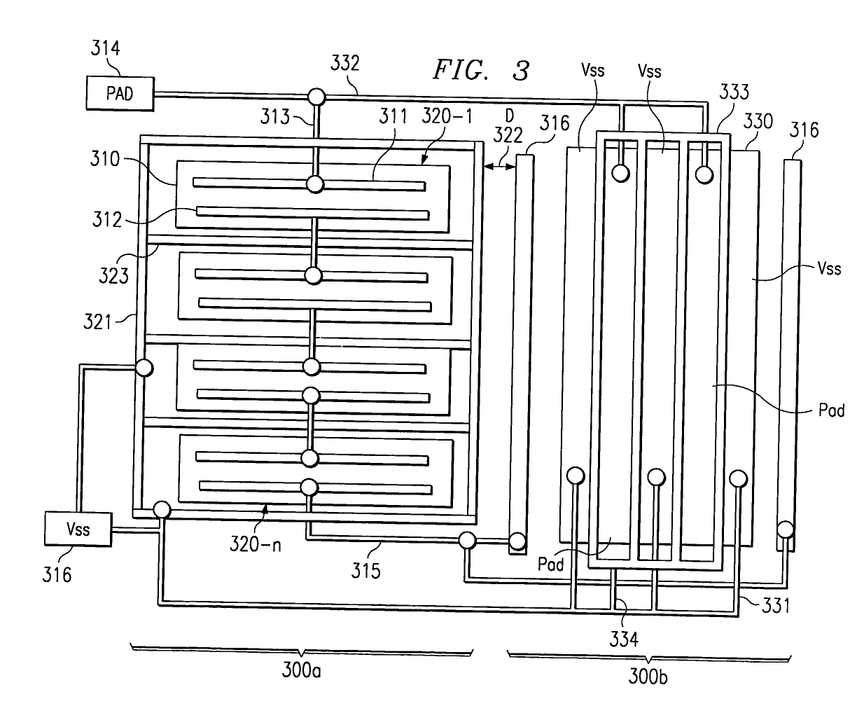

As discussed in FIGS. 2 and 3, the discharge circuit MOS transistor 103 is preferably multi-fingered, and the diodes 106-1 to 106-n in the drive circuit 102 are preferably finger-shaped.

FIG. 1B displays the basic approach of the present invention for an n-type substrate. 113d with a pMOS transistor 113. FIG. 1B represents the second preferred embodiment of the invention. The electrical connections and the reaction to an ESD pulse are analogous to the description in FIG. 1A for a p-type substrate and an nMOS transistor.

FIG. 1C illustrates the third embodiment of the invention. As in FIG. 1A, the MOS transistor 103 in the discharge circuit is an nMOS transistor, and the diode string includes diodes 106-1 to 1-6-n. The bias tap feeding substrate 103d, however, is taken from an extra diode 136. The resistor 107 in FIG. 1A is thus redundant.

FIG. 2 is a schematic cross section of the first embodiment of the invention, showing a protection structure generally designated 200 suitable for CMOS technology. Embedded in a semiconductor substrate 201 of a first conductivity type (for example, p-type) is a plurality of separate wells 202 of the opposite conductivity type (for example, n-type). In some devices, the embedding substrate may itself be a well. The separations 203 between the wells are provided by shallow trench isolations.

Within each well are anode diffusions 204 (for instance, p+) and cathode diffusions 205 (for instance, n+). The diffusions may be separated by shallow trench isolations 206. The diodes of the drive circuit are formed in each n-well and are interconnected by connectors 207; the diodes are forward biased. In the example of FIG. 2, the anode of the diode string is connected by metallization 208 to pad 209 and to the drain 220 of the nMOS transistor; the cathode of the diode string is connected by metallization 210 to substrate contacts 201a (p+ for p-type substrate, as in FIG. 2). What appears as two contacts 201a in FIG. 2, may actually be a ring, which is electrically floating but resistively coupled to ground.

The MOS transistor of the discharge circuit is formed by drain 220 (n+ diffusion in the example of FIG. 2) and source 221 (n+). Between source and drain is poly gate 222. Gate 222 is connected to source 221 and connected to ground 223 (Vss). As stated above, drain 220 is connected to pad 209. In an ESD event, it is the lateral current flow in the substrate of the MOS transistor, which creates the voltage drop necessary to turn-on the transistor and to safely discharge the ESD pulse to ground.

FIG. 3 is a simplified top view of a variation of the first embodiment of the invention. The MOS transistor is shown in the discharge circuit 300b, and the diode string in the drive circuit 300a; however, the diode string features a more heavily doped guard ring of the first conductivity type (for example, p+) surrounding each well of the opposite conductivity type (for example, n-type) in order to prevent latch-up. FIG. 3 emphasizes the elongated, finger-like layout of the structures and draws attention to a distance parameter D, which preferably should be large. The example in FIG. 3 employs again p-type substrate and an nMOS transistor.

The drive circuit 300a has a plurality of diodes 320-1 to 320-n located in separate n-wells 310. Each diode has finger-like p+ (311) and n+ (312) regions. They are interconnected in forward bias to form a string. The anode of this diode string is connected (313) to the pad 314, which needs ESD protection. The cathode of the diode string is connected (315) to p+ diffusions 316 as the contacts to the p-substrate. Contacts 316, as stripes near the MOS transistor, or as ring around the transistor, are electrically floating. Each n-well, with a diode inside, is surrounded by the p+ guard ring, generally designated 321. In order to keep the substrate resistance for the current flow at large values, and thus the voltage drop large, the distance D (322) between the guard ring and the substrate contact 316 should preferably be large.

In the example of FIG. 3, the transistor in discharge circuit 300b is shown as an nMOS transistor with the n+ diffusion 330 highlighted. One portion 331 of the n+ diffusion 330 is connected to Vss (ground), the other portion 332 to pad 314. The poly gates 333 of the nMOS transistor are shown elongated, highlighting the fact that the nMOS transistor is designed as a multi-finger transistor. Using this design principle, the layout can be highly effective while constraining the consumption of valuable silicon area. The poly gates 333 are connected to Vss (ground) 316 via connection 334. The transistor substrate (not marked in FIG. 3) has contacts 316.

In FIG. 3, the diodes 320-1 to 320-n of the drive circuit 300a are also designed in elongated, finger-like configuration. All anodes 311 and all cathodes 312 are finger-like, and so are the guard ring portions 323.

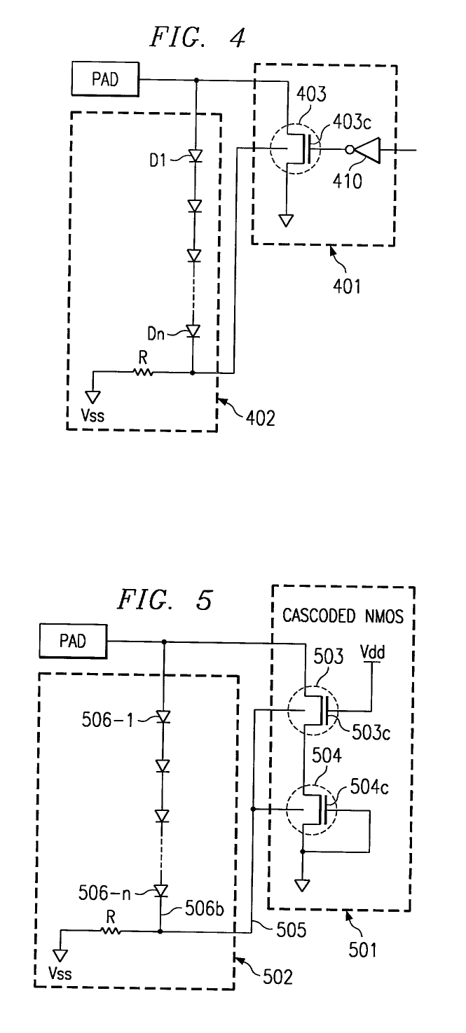

FIG. 4 depicts a schematic circuit diagram of the fourth embodiment of the invention, wherein the ESD protection circuit, based on the substrate current pump scheme of the invention, is used for output pad protection. In order to achieve this goal, MOS transistor 403 (nMOS or pMOS, as the case may be) of the discharge circuit 401 has its gate 403c connected to a pre-driver circuit 410. With substrate bias initiated by the substrate current from the drive circuit 402, the MOS transistor forms a pre-driver controlled device, or self-protection device.

FIG. 5 depicts a schematic circuit diagram of the fifth embodiment of the invention aiming at voltage tolerant input or output protection, wherein the substrate bias is applied to cascoded transistors. In the example of FIG. 5, the cascoded transistors in the discharge circuit 501 are represented by two nMOS transistors 503 and 504 in the same p-type substrate; the gate 503c of transistor 503 is connected to Vdd and the gate 504c of transistor 504 is connected to ground. The substrate 505 of both transistors is connected to the cathode 506b of the string of diodes 506-1 to 506-n in the drive circuit 502.

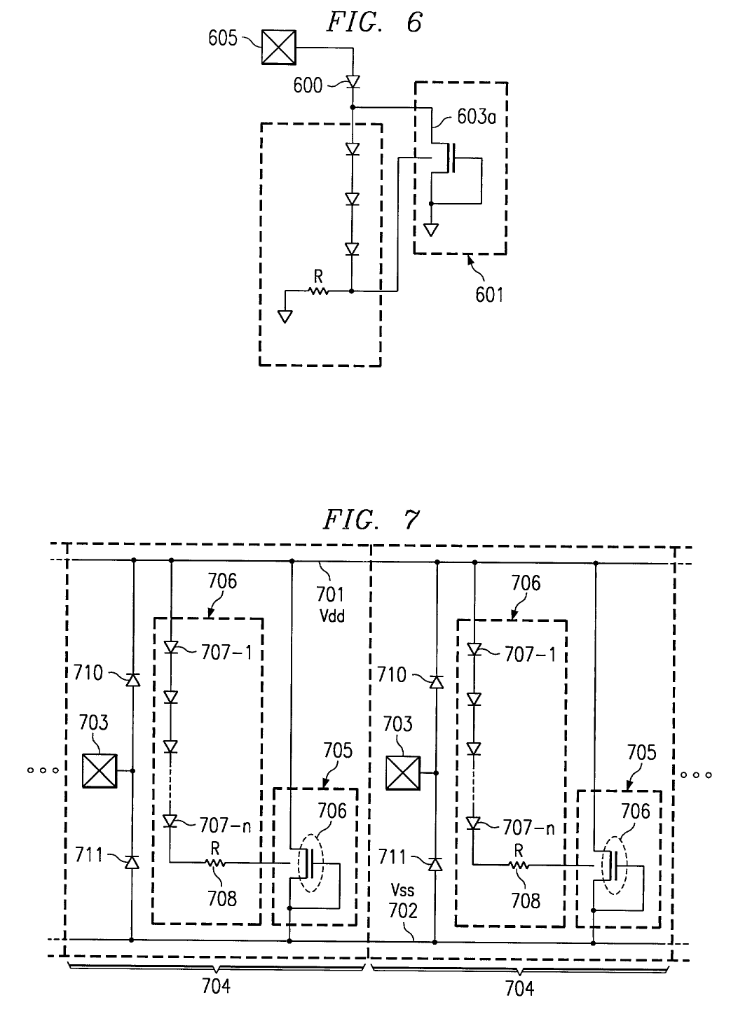

FIG. 6 depicts a schematic circuit diagram of the sixth embodiment of the invention. A diode 600 is in series between the pad 605 and the drain 603a of the MOS transistor of the discharge circuit 601. This embodiment is the preferred solution for protection when pad 605 is an I/O pad, because diode 600 (for example, a 3.5 V diode) functions as an isolation diode.

It is the technical advantage of the sixth embodiment that diode 600 drastically lowers the leakage current at pad 605, originating from the discharge circuit 601, by about an order of magnitude. Diode 600 further lowers the capacitance.

FIG. 7 depicts a schematic circuit diagram of the seventh embodiment of the invention. FIG. 7 shows the Vdd line 701 and the Vss line 702. Between Vdd and Vss are a plurality of pads 703 (for example, I/O pads) within a cell 704. In each cell 704 are ESD protection circuits for protecting the pads 703. Each protection circuits consists of a discharge circuit 705 and a drive circuit 706. Each discharge circuit has an MOS transistor 707. Each drive circuit has a string of diodes 707-1 to 707-n. In an ESD event, the voltage drop of the drive current across substrate resistance 708 creates the voltage drop needed to turn on transistor 706 and discharge the ESD pulse safely to ground (Vss). The arrangement of FIG. 7 thus represents multiple or distributed diode-triggered MOS clamps, placed between Vdd and Vss preferably at each I/O cell.

The isolation diodes 710 and 711 serve to dramatically lower the leakage current and the capacitance to the pad 703.

The ESD current is shunted to the Vdd/Vss buses 701 and 702, respectively, by the string of diodes connected to pad 703 such that they are reverse biased during normal operation. During an ESD event, the string of diodes conducts and a potential difference builds up between the Vdd and Vss buses until the ESD pulse is discharged by triggering the diode-triggered MOS clamps.

While this invention has been described in reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

We claim:

1. A protection circuit for protecting a CMOS integrated circuit in a substrate of a first conductivity type against an ESD pulse, comprising:
a discharge circuit having an MOS transistor formed in said substrate, operable to discharge said ESD pulse to ground; and
a drive circuit including a plurality of diodes, located in separate wells of the opposite conductivity type and connected as a string in forward direction, operable to use a portion of said ESD pulse's voltage to enter a high conductance, conductivity-modulated state and to provide substrate current, and consequently a substrate voltage drop, to turn-on said MOS transistor to ground said ESD pulse.

2. The protection circuit according to claim 1 wherein said plurality of diodes in the drive circuit cause fast response time of the circuit.

3. The protection circuit according to claim 1 wherein said drive circuit has low capacitance and low leakage current.

4. The protection circuit according to claim 1 further comprising additional currents from each diode, contributed to said substrate current to bias said MOS transistor into turn-on.

5. The protection circuit according to claim 1 wherein the number of diodes in said plurality can be adjusted dependent on the voltage limit of the intended device application by connecting said drain to a select node within said string of diodes, tapping off a select number of diodes.

6. The protection circuit according to claim 1 wherein said drive circuit further comprises:
a pad for receiving a portion of said ESD pulse's voltage;
the anode of said string of diodes connected to said pad;
the cathode of said string of diodes connected to the substrate of said MOS transistor, and, via a resistor, to ground potential.

7. The protection circuit according to claim 6 wherein said resistor is the substrate resistance or an additional resistive element including a poly resistor.

8. The protection circuit according to claim 1 wherein said discharge circuit further comprises:
a pad for receiving a portion of said ESD pulse; and
an MOS transistor having a source, gate and drain; said source and gate tied to ground potential; and said drain connected to said pad.

9. The protection circuit according to claim 6 and 8 wherein said pad is an input pad or a power pad.

10. The protection circuit according to claim 6 wherein said drain connection to a signal input pad is tapped off at a select node within said string of diodes, thus providing a discharge circuit having low capacitance and low leakage current.

11. The protection circuit according to claim 1 wherein said cathode of said string of diodes is resistively connected to ground potential.

12. The protection circuit according to claim 1 wherein said discharge circuit MOS transistor is a multi-fingered transistor.

13. The protection circuit according to claim 1 wherein said drive circuit has finger-shaped diodes.

14. The protection circuit according to claim 1 wherein said wells of opposite conductivity are separated by trench isolations.

15. The protection circuit according to claim 1 wherein said wells of opposite conductivity are embedded in a well of the first conductivity.

16. The protection circuit according to claim 1 wherein said first conductivity type is p-type and said discharge circuit MOS transistor is an nMOS transistor.

17. The protection circuit according to claim 1 wherein said first conductivity type is n-type and said discharge circuit MOS transistor is a pMOS transistor.

18. The protection circuit according to claim 1 wherein said discharge circuit further comprises:
a pad for receiving a portion of said ESD pulse; and
an MOS transistor having a source, gate and drain; said gate controlled by a pre-driver to render said MOS transistor as a self-protection device with substrate bias; said source tied to ground potential; and said drain connected to said pad.

19. The protection circuit according to claim 6 and 18 wherein said pad is an output pad.

20. A protection circuit for protecting a CMOS integrated circuit in a substrate of a first conductivity type against an ESD pulse at a pad, comprising:
a discharge circuit having a cascoded stack of MOS transistors formed in said substrate, operable to discharge said ESD pulse to ground; and
a drive circuit including a plurality of diodes, located in separate wells of the opposite conductivity type and connected as a string in forward direction, operable to use a portion of said ESD pulse's voltage to enter a high conductance, conductivity-modulated state and to provide substrate current, and consequently a substrate voltage drop, to turn-on said cascoded MOS transistors to ground said ESD pulse.

21. The protection circuit according to claim 20 wherein said discharge circuit having cascoded MOS transistors provides high voltage protection.

22. The protection circuit according to claim 20 wherein said pads may be input pads, power pads, or output pads.

23. The protection circuit according to claim 20 wherein said first conductivity type is p-type and said discharge circuit MOS transistor is an nMOS transistor.

24. The protection circuit according to claim 20 wherein said first conductivity type is n-type and said discharge circuit MOS transistor is a pMOS transistor.

25. A protection circuit for protecting a CMOS integrated circuit in a substrate of a first conductivity type against an ESD pulse at an I/O pad, comprising:
a discharge circuit having an MOS transistor formed in said substrate, operable to discharge said ESD pulse to ground, said transistor having source, gate and drain, said source and gate tied to ground potential; and
a drive circuit including a diode connected to said I/O pad, said diode in series between said pad and said drain of said MOS transistor and a plurality of diodes, located in separate wells of the opposite conductivity type and connected as a string in forward direction; said diode string operable to use a portion of said ESD pulse's voltage to enter a high conductance, conductivity-modulated state and to provide substrate current, and consequently a substrate voltage drop, to turn-on said MOS transistor to ground said ESD pulse.

26. The protection circuit according to claim 25 wherein said first conductivity type is p-type and said discharge circuit MOS transistor is an nMOS transistor.

27. The protection circuit according to claim 25 wherein said first conductivity type is n-type and said discharge circuit MOS transistor is a pMOS transistor.

28. A protection circuit for protecting a CMOS integrated circuit in a substrate of a first conductivity type against an ESD pulse, said integrated circuit having a plurality of I/O pads, a bus line tied to Vdd potential and a bus line tied to ground (Vss) potential, comprising:
diodes tied to each of said I/O pads such that they are connected to said Vdd and Vss bus lines, respectively, said diodes shunting an ESD current to said Vdd/Vss buses while being reverse biased during normal operation;
a discharge circuit for each of said I/O pads, said discharge circuit having an MOS transistor formed in said substrate, operable to discharge an ESD pulse at said I/O pad to ground, said transistor having source, gate and drain, said source and gate tied to Vss potential and said drain tied to Vdd potential; and
a drive circuit including a plurality of diodes, located in separate wells of the opposite conductivity type and connected as a string in forward direction, operable to use a portion of said ESD pulse's voltage to enter a high conductance, conductivity-modulated state, to form a potential difference between said Vdd and Vss buses, and to turn-on said MOS transistor to ground said ESD pulse.

29. The protection circuit according to claim 28 wherein said first conductivity type is' p-type and said discharge circuit MOS transistor is an nMOS transistor.

30. The protection circuit according to claim 28 wherein said first conductivity type is n-type and said discharge circuit MOS transistor is a pMOS transistor

31. A method for protecting an integrated circuit from an ESD pulse, comprising the steps of:
receiving the ESD pulse at discharge circuitry on a substrate at the pad of the integrated circuit;
diverting a portion of the ESD pulse to a plurality of diodes connected as a string in forward direction to generate substrate current; and
biasing the substrate of the discharge circuitry with said substrate current so as to turn on MOS transistors in the discharge circuitry.

32. The method according to claim 31 further comprising the step of conducting the remainder of said ESD pulse to ground potential through the discharge circuitry.

33. The method according to claim 31 wherein said pad is an input pad, power pad, or output pad.
